(19) United States
(12) Patent Application Publication
(10) Pub. No.: US 2025/0360402 A1
(43) Pub. Date: Nov. 27, 2025

(54) AUTOMATIC CINEMATIC MODE FALLBACK FOR HIGH LATENCY CONNECTIONS DURING XR STREAMING

(71) Applicant: Sony Interactive Entertainment Inc., Tokyo (JP)

(72) Inventor: Steven Osman, San Mateo, CA (US)

(21) Appl. No.: 18/672,597

(22) Filed: May 23, 2024

(51) Int. Cl. A63F 13/358; G06T 19/00

(52) U.S. Cl. CPC A63F 13/358; G06T 19/006

(57) ABSTRACT

Techniques for streaming (and non-streaming) XR applications that, when high latency is detected, automatically and naturally falls back on a cinematic experience in VR. For example, the game may be shown on a movie theater screen in a locally rendered environment where the game is played.

### FIELD

The present application relates generally to automatic cinematic mode fallback for high latency connections during extended reality (XR) streaming.

### BACKGROUND

Streaming XR applications are very sensitive to latency. High latency environments not only can produce a degraded experience for video game players, but they also run the risk of causing motion sickness or loss of balance by the player.

### SUMMARY

Present principles understand that a high latency situation can be caused by a high latency phase in the connection between the client and the streaming server. Alternatively, the machine rendering the game may slow down. For instance, if the system that is rendering the game is overheating, it may be throttled down and the game can become less responsive.

In recognizing the above technical challenges, the techniques herein provide for streaming (and non-streaming) XR applications that, when high latency is detected, automatically and naturally falls back on a cinematic experience in VR (e.g., a movie theater screen in a locally rendered environment where the game is played).

Depending on the embodiment, a variety of actions can be taken when the client detects a high latency situation. The game may be rendered as a 2D image on a cinema screen in the virtual environment. The control scheme can switch to transition from motion controls to using dual-stick for navigation. The game can be automatically paused to allow the player to adjust to the new situation. A pre-loaded theater environment can be used on the client to make the environment more thematic. An AI agent can temporarily control the user's character as the player adapts to the new environment. Video pass-through may be enabled (outside of the 2D image) to give the user a reference of where he is in their room. The server may be notified of this mode so it can reconfigure itself. After a reasonable threshold of low latency the process may be reversed and the user may be transitioned back to an immersive environment. The user may be prompted before the transition back to the immersive environment (for example, if the user is aware that there will be intermittent periods of high latency, she may choose to stay in the cinematic environment).

Accordingly, a method includes presenting an extended reality (XR) computer simulation on an XR display. The method also includes identifying a latency associated with presenting the XR computer simulation, and responsive to the latency, switching presentation of the XR computer simulation to a two dimensional (2D) presentation.

In some examples the method may include switching presentation of the XR computer simulation to the 2D presentation and presenting the 2D presentation on the XR display, such as a movie theater image in the virtual environment. In other examples the method may include switching presentation of the XR computer simulation to the 2D presentation and presenting the 2D presentation on a display other than the XR display, such as a display of a mobile computing device.

In some implementations the method can include switching presentation of the XR computer simulation to the 2D presentation responsive to the latency at least equaling a first latency. The method further may include presenting a prompt to switch presentation of the computer simulation back to XR responsive to the latency reducing below the first latency.

In another aspect, a processor system is configured to identify that a latency associated with rendering an extended reality (XR) computer game on a display is at least equal to a first latency. Responsive to identifying that the latency is at least equal to the first latency, the system is configured to switch from rendering the XR computer game on the display to rendering a two dimensional (2D) video on a display.

In another aspect, a device includes at least one computer memory that is not a transitory signal and that in turn includes instructions executable by at least one processor system to identify a latency in computer game presentation in extended reality (XR), and responsive to the latency, switch from computer game presentation in XR to computer game presentation in two dimensions (2D).

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example architecture consistent with present principles;

FIG. 3 illustrates example logic in example flow chart format;

FIG. 4 illustrates a screen shot from the XR headset or other display indicating that a game is paused due to latency;

FIGS. 5 and 6 illustrate screen shots from the XR headset or other display indicating that a game is being transferred;

FIG. 7 illustrates a screen shot indicating that non-XR controls are now enabled owing to a high latency game environment;

FIG. 8 illustrates a screen shot from the XR headset or other display indicating that an agent is available to control a player character during periods of latency;

FIG. 9 illustrates a screen shot from the XR headset or other display showing video pass through of real world objects to orient the player in conditions of high latency;

FIG. 10 illustrates a screen shot from the XR headset or other display indicating that latency is reduced and giving the player the option to transition back to XR;

FIG. 11 illustrates alternate example logic in example flow chart format; and

FIG. 12 illustrates an example computer simulation controller.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

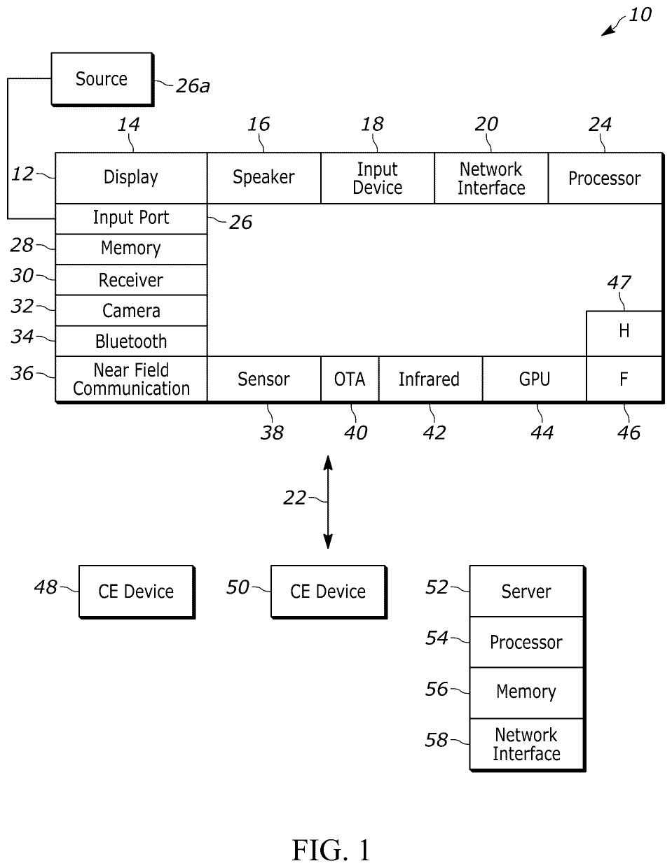

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

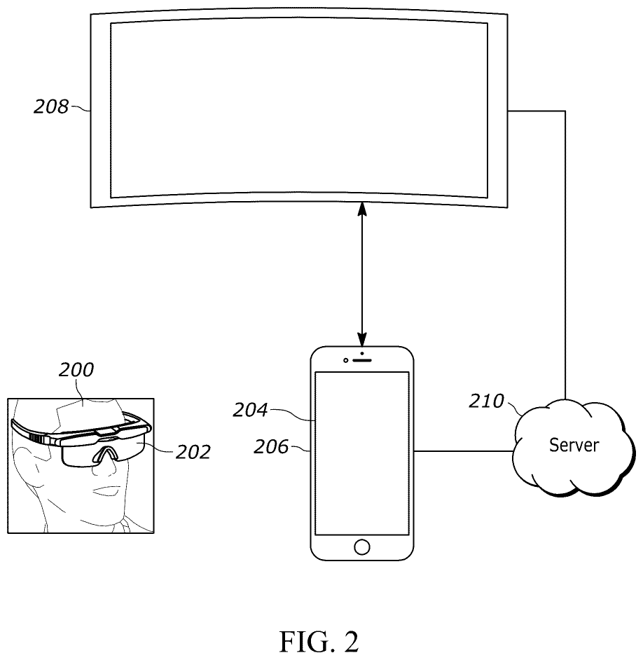

Refer now to FIG. 2. A computer simulation such as a computer game may be presented to a player 200 on a head-mounted display (HMD) 202 or other type of headset. The game may be presented as an extended reality (XR) game such as a three dimensional (3D) virtual reality (VR) or augmented reality (AR) game. A 3D effect may be achieved by presenting images stereoscopically, with sufficient offset between separate video streams for the left and right eye displays of the HMD to produce a 3D effect.

In the example environment shown, particularly for augmented reality applications the player 200 may be able to see a display 204 of a mobile computing device 206 such as a mobile phone as well as a large cinematic display 208 in a movie theater. It is to be understood that alternative to being real world displays, the displays 204, 208 may be virtualized to appear on the HMD 202 in a VR-only application. One or more game servers 210 may provide streaming computer simulations to any of the displays described herein. The server 210 may be a cloud server and/or a local computer game console nearby the player 200.

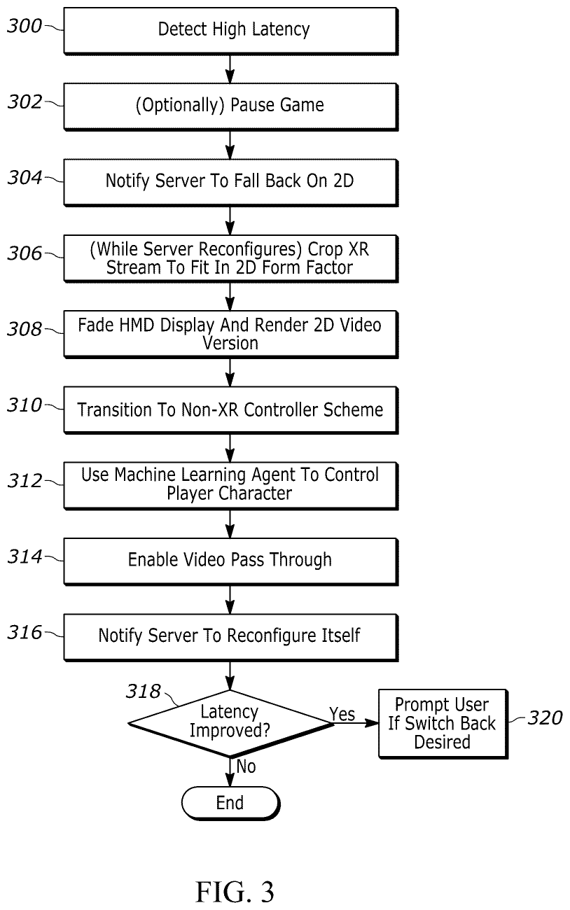

FIG. 3 illustrates, in example non-limiting flow chart format, example techniques that may be implemented consistent with present principles. An XR computer simulation such as an XR computer game may be resented on the HMD 202 shown in FIG. 2. State 300 indicates that during presentation of the XR game, high latency is detected. Latency meeting or exceeding a threshold latency may be considered to be high. Appropriate techniques for detecting latency may be used, such as by using a ping method in which a specific signal is exchanged between server and client and latency determined to be the period from when the ping was initiated to when a ping-back is received.

Proceeding to state 302, responsive to the high latency, the computer game may be automatically paused.

State 304 indicates that responsive to high latency, presentation of the XR computer game may be switched to a two dimensional (2D) presentation. This may be done by signaling from the HMD 202 to the server 210 in FIG. 2 to switch to 2D presentation, such as by sending only a single (non-stereoscopic) game stream to the HMD. As indicated at state 306, if desired, during the period the server 210 is reconfiguring to 2D presentation prior to switching away from XR, the XR stream may be cropped to fit into a 2D form factor. At state 308, once the server is reconfigured for 2D, the XR presentation may be transitioned as by fading into a 2D version of the same game.

The 2D presentation itself may be presented on the HMD 202 in a 2D display image region in the virtual environment, such as an image of the display 204 of the mobile device or theater cinematic display 208 shown in FIG. 2. Or, as mentioned previously the 2D version of the game may be presented on real world mobile devices or theater displays and seen by the player 200 through the HMD 202.

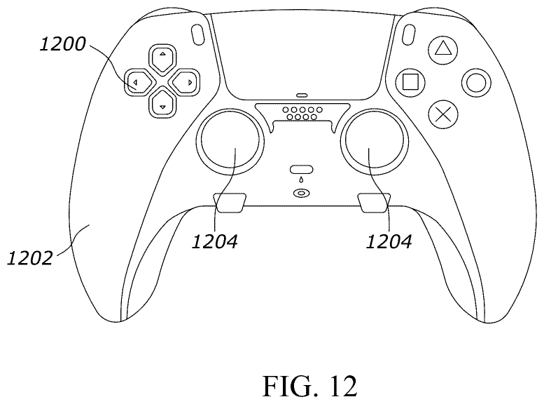

State 310 indicates that responsive to the high latency, game control input may be switched from motion controls on a game controller to dual-stick for navigation. For example, referring briefly to FIG. 12, navigation input may be switched from motion control buttons 1200 on a game controller 1202 to left and right joystick-type input devices 1204 of the controller 1202.

Returning to FIG. 3, at state 312, if desired when latency is high control of a player character (PC) may be shifted to an agent as may be embodied in a machine learning (ML) model trained to control computer game characters. Also, at state 314, responsive to the high latency, video pass-through of real world images may be enabled on the HMD 202. This may be done by reducing the opacity of the displays of the HMD by, for instance, adjusting the transmissivity of liquid crystal elements in the display.

State 316 indicates that the HMD in response to high latency may notify the server to reconfigure itself and likewise when latency improves, to switch back to XR 3D rendering. This is represented by state 318 in FIG. 3, which indicates that when latency falls below the threshold to an acceptable level the logic can move to state 320 to prompt on the HMD to indicate whether a switch back to XR is desired.

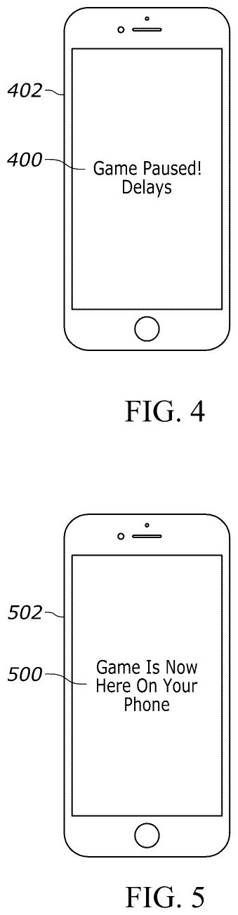

FIG. 4 illustrates a notification 400 that may be presented on a display 402 such as any display herein that the game has been paused due to latency.

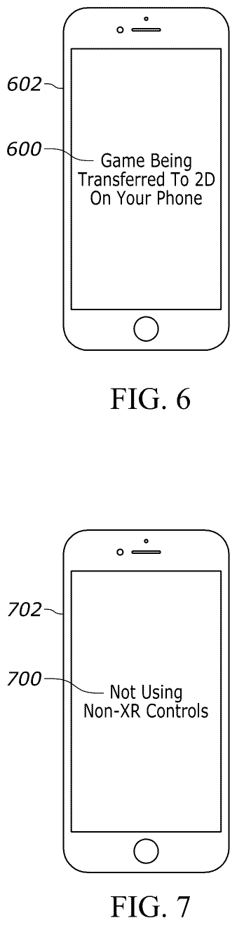

FIG. 5 illustrates a notification 500 that may be presented on a display 502 such as any display herein that the game is available in 2D on a real world or virtual display. FIG. 6 illustrates a similar notification 600 that may be presented on a display 602 such as any display herein that the game is in the state of being transferred to 2D due to latency.

FIG. 7 illustrates a notification 700 that may be presented on a display 702 such as any display herein that is consistent with state 310 in FIG. 3 that non-XR controls on the controller have been enabled.

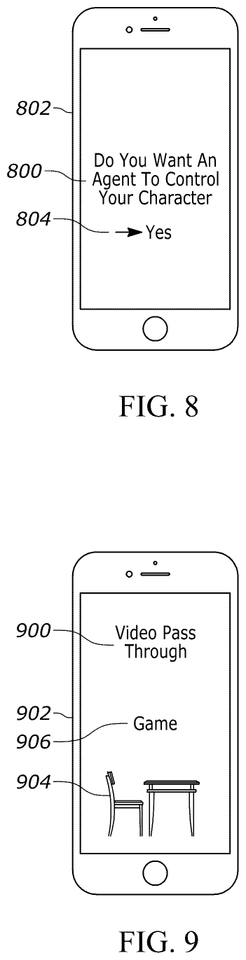

FIG. 8 illustrates a prompt 800 that may be presented on a display 802 such as any display herein that is consistent with state 312 of FIG. 3 to the effect of giving the player the option to transfer control of the player's character to an agent. A selector 804 may be provided for selection by the player to effect the transfer of control.

FIG. 9 illustrates a notification 900 that may be presented on a display 902 such as any display herein that is consistent with state 314 of FIG. 3 to the effect that video pass through has been implemented in which images 904 of real world objects surrounding the player 200 can be seen through the HMD. Among the images 904 are a chair and a table. Also, an image 906 of a virtual 2D display may be presented, showing a 2D version of the computer simulation after transitioning from XR due to high latency.

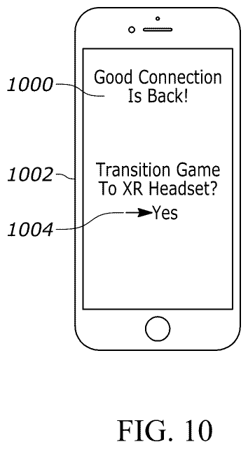

FIG. 10 illustrates a notification 1000 that may be presented on a display 1002 such as any display herein that is consistent with state 318 of FIG. 3 to the effect that latency has improved. A selector 1004 may be provided to enable the player to select to transition back to XR from 2D.

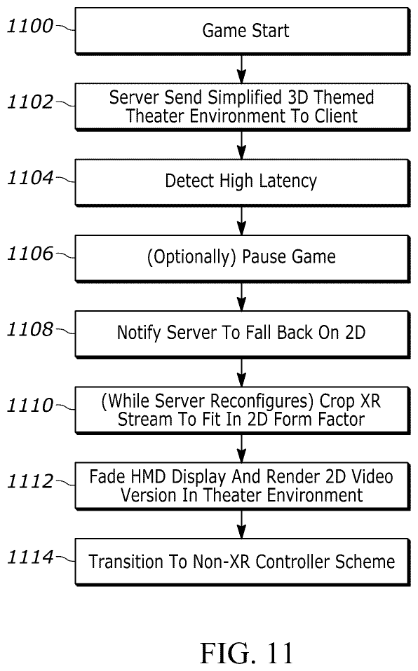

FIG. 11 illustrates that in addition to techniques above, the server 210 in FIG. 2 can pre-load a theater environment that is themed for the game being played. When the client device such as the HMD 202 detects a high latency situation, it can do a 2D rendering in the themed environment.

The game presentation is commenced at state 1100. At state 1102 the server sends to the HMD 202 a simplified 3D theater environment to the HMD 202. When high latency is detected at state 1104, the logic may proceed according to principles discussed herein, including auto pause of the game at state 1106 and a notification to the server at state 1108 to switch from XR to 2D game rendering. As the server reconfigures at state 1110 the current XR stream may be cropped to fit into a 2D form factor. State 1112 indicates that once the server is reconfigured for 2D, the XR presentation may be transitioned as by fading into a 2D version of the same game within the themed environment from state 1102. State 1114 indicates that responsive to the high latency. game control input may be switched from motion controls on a game controller to dual-stick for navigation.

While the particular embodiments are herein shown and described in detail, it is to be understood that the subject matter which is encompassed by the present invention is limited only by the claims.

What is claimed is:

1. A method comprising:
presenting an extended reality (XR) computer simulation on an XR display;
identifying a latency associated with presenting the XR computer simulation; and
responsive to the latency, switching presentation of the XR computer simulation to a two dimensional (2D) presentation.

2. The method of claim 1, comprising switching presentation of the XR computer simulation to the 2D presentation and presenting the 2D presentation on the XR display.

3. The method of claim 1, comprising switching presentation of the XR computer simulation to the 2D presentation and presenting the 2D presentation on a display other than the XR display.

4. The method of claim 3, wherein the display other than the XR display comprises a display of a mobile computing device.

5. The method of claim 3, wherein the display other than the XR display comprises a movie theater display in a virtual environment.

6. The method of claim 1, comprising switching presentation of the XR computer simulation to the 2D presentation responsive to the latency at least equaling a first latency.

7. The method of claim 6, comprising presenting a prompt to switch presentation of the computer simulation back to XR responsive to the latency reducing below the first latency.

8. The method of claim 1, comprising, responsive to the latency, switching from motion controls on a game controller to using dual-stick for navigation.

9. The method of claim 1, comprising, responsive to the latency, automatically pausing the computer simulation.

10. The method of claim 1, comprising presenting a pre-loaded theater environment in the 2D presentation.

11. The method of claim 1, comprising, responsive to the latency, switching control of a player character to at least one machine learning (ML) model.

12. The method of claim 1, comprising, responsive to the latency, enabling video pass-through of real world images on the XR display.

13. A processor system configured to:
identify that a latency associated with rendering an extended reality (XR) computer game on a display is at least equal to a first latency; and
responsive to identifying that the latency is at least equal to the first latency, switch from rendering the XR computer game on the display to rendering a two dimensional (2D) video on a display.

14. The processor system of claim 13, wherein the display on which the 2D video is rendered comprises the display on which the XR computer game was rendered.

15. The processor system of claim 13, wherein the display on which the 2D video is rendered comprises a display other than the display on which the XR computer game was rendered.

16. The processor system of claim 13, wherein the processor system is configured for presenting a prompt to switch presentation of the computer simulation back to XR responsive to the latency reducing below the first latency.

17. The processor system of claim 13, wherein the processor system is configured for, responsive to the latency, switching from motion controls on a game controller to using dual-stick for navigation.

18. The processor system of claim 13, wherein the processor system is configured for, responsive to the latency, enabling video pass-through of real world images on the display on which the XR computer game is rendered.

19. A device comprising:
at least one computer memory that is not a transitory signal and that includes instructions executable by at least one processor system to:
identify a latency in computer game presentation in extended reality (XR); and
responsive to the latency, switch from computer game presentation in XR to computer game presentation in two dimensions (2D).

20. The device of claim 19, comprising the at least one processor system.
